(19) United States
(12) Patent Application Publication
(10) Pub. No.: US 2006/0056199 A1
(43) Pub. Date: Mar. 16, 2006

(54) Surface light source unit and liquid crystal display device having the same

(76) Inventors: Cheol-jin Park, Suwon-si (KR); Hyeon-yong Jang, Osan-si (KR); Ki-yoon Lee, Suwon-si (KR)

Correspondence Address: STANZIONE & KIM, LLP, 919 18TH STREET, N.W., SUITE 440, WASHINGTON, DC, 20006, US

(21) Appl. No.: 11/174,530

(22) Filed: Jul. 6, 2005

(30) Foreign Application Priority Data
Sep. 10, 2004 (KR) 2004-72567

(51) Int. Cl. F21V 7/04

(52) U.S. Cl. 362/611

(57) ABSTRACT

A surface light source unit and an LCD device having the same having an improved structure to minimize a dark portion caused by an outer electrode portion. The surface light source unit of the LCD device includes a discharge portion formed between a first substrate and a second substrate disposed opposite to the first substrate, a first outer electrode portion disposed on the first substrate inside the discharge portion to be supplied with power, a first frit disposed on the first substrate inside the discharge portion opposite the first outer electrode portion. The discharge portion performs a discharge according to the power supplied to the first outer electrode portion. Since the first frit increases the number of secondary emitting electrons, the dark portion can be minimized.

CROSS-REFERENCE TO RELATED APPLICATIONS

This application claims the benefit under 35 U.S.C. § 119 of Korean Patent Application No. 2004-72567, filed on Sep. 10, 2004, the entire content of which is incorporated herein by reference.

### BACKGROUND OF THE INVENTION

1. Field of the Invention

The present general inventive concept relates to a surface light source unit and a liquid crystal display (LCD) device having the same.

2. Description of the Related Art

Generally, an LCD device is a flat display device that precisely controls a liquid crystal to display data that is processed by a data processor in the form of text, images, and moving pictures.

Unlike display devices having light emitting capabilities, such as a cathode ray tube, the LCD device requires a separate light source unit because it is a non-light-emitting display device.

A one-dimensional light source (e.g., a light-emitting diode (LED)) or a two dimensional light source (e.g., a cold cathode fluorescent lamp (CCFL)) is used as the light source unit. However, since the light-emitting diode or the cold cathode fluorescent lamp typically has low luminance uniformity, an optical member, such as a diffusion sheet or a prism sheet, is required to make the luminance uniform.

However, the optical member may cause light loss in the LED or the CCFL. For this reason, the LED or the CCFL has a low light efficiency, and a structure thereof may be complicated. This increases the production cost and reduces luminance uniformity.

In an attempt to solve the problems described above, a surface light source unit that directly emits light from a surface thereof has been developed. The surface light source unit includes a surface light source body divided into a plurality of discharge portions, and outer electrode portions provided on a top surface and a bottom surface thereof and at both ends of the surface light source body to apply a discharge voltage thereto.

In the surface light source unit, the discharge voltage externally applied to the outer electrode portions causes a plasma discharge in each of the discharge portions. The plasma discharge produces ultraviolet rays. The ultraviolet rays are converted into visible rays by a fluorescent layer deposited on an inner wall of the surface light source unit (i.e., inside the discharge portions).

FIG. 1 illustrates a conventional surface light source unit 140. The conventional surface light source unit 140 includes a first outer electrode portion 100, a second outer electrode portion 102, a first substrate 110, a second substrate 112, a first fluorescent layer 130, a second fluorescent layer 132, and a reflecting layer 120. The first outer electrode portion 100 is deposited on a bottom surface of the first substrate 110 while the second outer electrode portion 102 is deposited on a top surface of the second substrate 112. The reflecting layer 120 is deposited on a top surface of the first substrate 110 opposite the first outer electrode portion 100, and the first fluorescent layer 130 is deposited on the reflecting layer 120. The second fluorescent layer 132 is deposited on a bottom surface of the second substrate 112 opposite the second outer electrode portion 102.

The first substrate 110 and the second substrate 112 are formed of glass. However, glass has a drawback in that it has low secondary electron emitting coefficient and decreases light efficiency during the discharge. In other words, since a light source is required to generate light using a small amount of energy, high efficiency is required when converting power into light. Since the glass has a low secondary electron emitting coefficient, it is difficult to obtain a desired amount of light when using glass in the first and second substrates 110 and 112.

Additionally, as illustrated in FIG. 1, the surface light source unit 140 that functions as a light-emitting portion is partially covered by the outer electrode portion. Therefore, light emitted from the surface light source body is blocked by the first and second outer electrode portions 100 and 102. For this reason, the surface light source unit 140 includes a dark portion corresponding to the outer electrode portions 100 and 102 and having a luminance that is lower than that of an effective light-emitting region of the surface light source unit 140. As a result of the dark portion, the surface light source unit 140 cannot obtain a uniform luminance, and display quality of the LCD device deteriorates.

### SUMMARY OF THE INVENTION

Accordingly, the present general inventive concept provides a surface light source unit and an LCD device having the same, which has an improved structure and minimizes a dark portion caused by an outer electrode portion of the surface light source unit.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a surface light source unit including a first substrate and a second substrate, a discharge portion formed between the first substrate and the second substrate, a first outer electrode portion disposed on the first substrate outside the discharge portion to be supplied with power, and a first frit disposed on the first substrate inside the discharge portion and opposite the first outer electrode portion. The discharge portion performs a discharge according to the power supplied to the first outer electrode portion.

The surface light source unit may further include a second frit disposed on the second substrate inside the discharge portion across from the first frit, a second outer electrode portion disposed on the second substrate outside the discharge portion and opposite the second frit, and a reflecting layer disposed between the first substrate and the first frit. The first and second frits may comprise PbO.

The first and second frits may further comprise an alkali metal oxide, such as MgO, BaO, CeO, and SrO. In addition, the first and second frits may have a thickness of 100 micrometers (μm) or less. The first and second frits may have one of a quadrangular structure, a straight line patterned structure, and one-dimensional repeated shape structure. The first frit may have the same size as that of the first outer electrode portion.

The foregoing and/or other aspects and advantages of the present general inventive concept may also be achieved by providing an LCD device including a support case with a support frame having a window, an LCD panel provided in the support case to display images using incident light, and a surface light source unit to emit light to the LCD panel. The surface light source unit includes a first substrate and a second substrate, a discharge portion formed between the first substrate and the second substrate, a first outer electrode portion disposed on the first substrate outside the discharge portion to be supplied with power, a first frit disposed on the first substrate inside the discharge portion and opposite the first outer electrode portion. The discharge portion performs a discharge according to the power supplied to the first outer electrode portion. The first frit may comprise PbO.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a conventional surface light source unit;

FIG. 2 is an exploded perspective view of an LCD device according to the embodiment of the present general inventive concept;

FIG. 3 is a perspective view of a surface light source unit of the LCD device of FIG. 2;

FIG. 4 is a rear perspective view illustrating a rear side of a surface light source unit of the LCD device of FIG. 2;

FIG. 5 is a sectional view of the surface light source unit taken along line X-X′ of FIG. 3;

FIG. 6 illustrates an electrode of a surface light source unit according to an embodiment of the present general inventive concept;

FIG. 7 illustrates an electrode of a surface light source unit according to another embodiment of the present general inventive concept;

FIG. 8 illustrates frits that are adhered to upper and lower substrates according to an embodiment of the present general inventive concept;

FIG. 9 illustrates a difference between an energy distribution of the conventional surface light source unit of FIG. 1 and an energy distribution of the surface light source unit of the embodiments present general inventive concept; and

FIG. 10 illustrates a difference between an electric field distribution of the conventional surface light source unit of FIG. 1 and an electric field distribution of the surface light source unit of the embodiments of the present general inventive concept.

### DETAILED DESCRIPTION OF THE PREFERRED EMBODIMENTS

Reference will now be made in detail to the embodiments of the present general inventive concept, examples of which are illustrated in the accompanying drawings. Wherever possible, the same reference numbers will be used throughout the drawings to refer to the same or like parts.

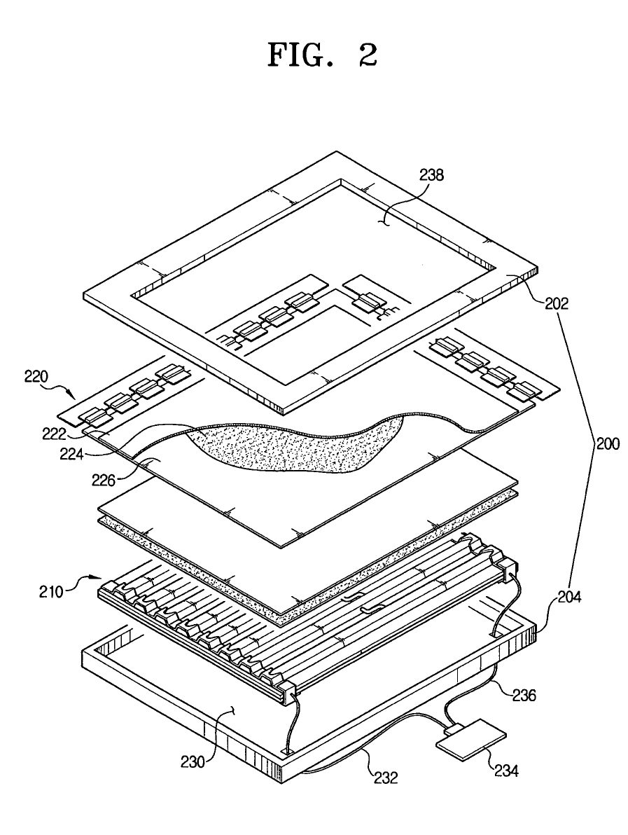

FIG. 2 is an exploded perspective view of an LCD device according to an embodiment of the present general inventive concept.

Referring to FIG. 2, the LCD device includes a surface light source unit 210, an LCD panel 220, and a support case 200.

The support case 200 includes a case body 204 to receive the surface light source unit 210 and the LCD panel 220, and a support frame 202 provided on the case body 204 to cover edges of the surface light source unit 210 and the LCD panel 220. The support frame 202 has a quadrangular shape and is provided with a window 238.

The surface light source unit 210 is received in a receiving portion 230 of the case body 204. Technical features of the surface light source unit 210 are described in more detail below. The surface light source unit 210 is connected with an outer power source 234 via power supply lines 232 and 236.

The LCD panel 220 includes a thin film transistor (TFT) substrate 226, a color filter substrate 222 formed to oppose the TFT substrate 226, and a liquid crystal 224 interposed between the TFT substrate 226 and the color filter substrate 222. The LCD panel 220 converts light emitted from the surface light source unit 210 into image light having image data.

Since the LCD panel 220 is susceptible to outer impact, its four weak portions are protected by the support frame 202 so that they may not be externally detached.

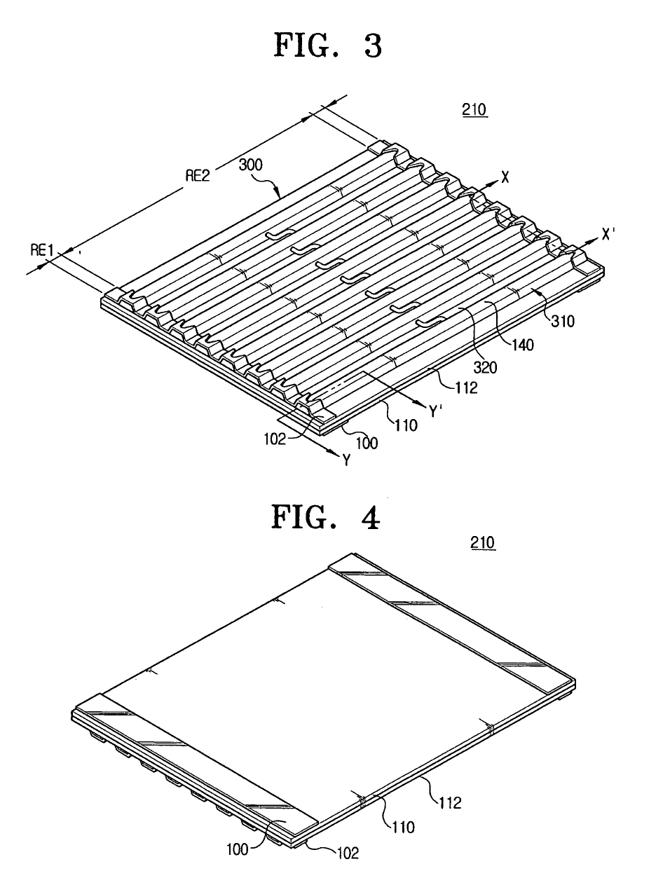

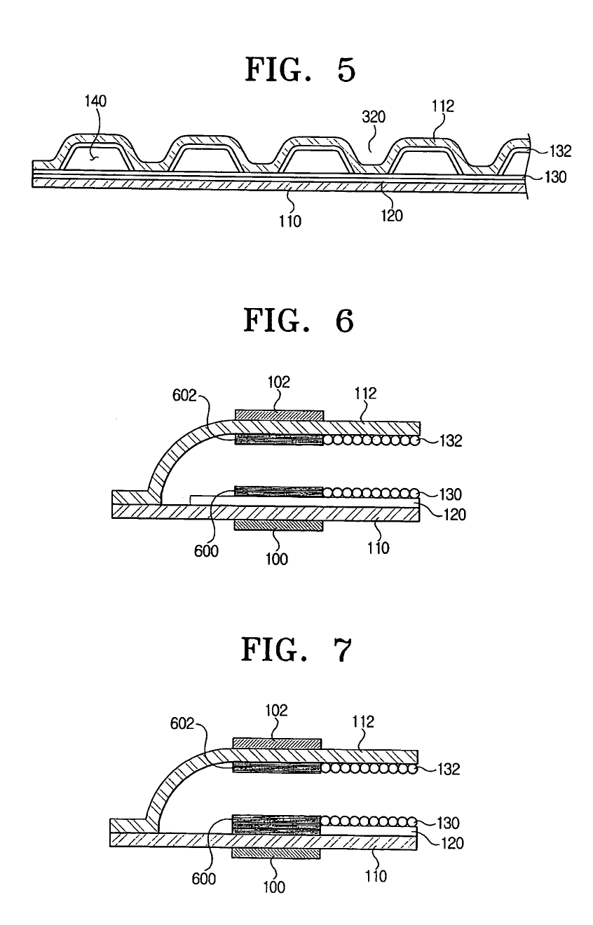

FIG. 3 is a perspective view illustrating the surface light source unit 210 of the LCD device of FIG. 2, FIG. 4 is a perspective view illustrating a rear side of the surface light source unit 210 of the LCD device of FIG. 2, and FIG. 5 is a sectional view of the surface light source unit 210 taken along line X-X′ of FIG. 3.

Referring to FIG. 3 and FIG. 4, the surface light source unit 210 includes a surface light source body 300 and first and second outer electrode portions 100 and 102 respectively provided at both ends of the surface light source body 300.

The surface light source body 300 includes first and second substrates 110 and 112 that comprise bottom and top surfaces thereof, respectively.

The first substrate 110 has a flat shape. The first substrate 110 may be formed of a transparent glass substrate that transmits visible rays and shields ultraviolet rays. Alternatively, the first substrate 110 may be formed of other transparent materials.

Referring to FIG. 5, a reflecting layer 120 and a first fluorescent layer 130 are deposited between the first substrate 110 and a plurality of discharge chambers 140.

The second substrate 112 is spaced apart from the first substrate 110 and has a non-flat shape to form the plurality of discharge chambers 140 and a plurality of chamber partitions 320. The discharge chambers 140 also have a non-flat shape. In other words, as illustrated in FIG. 5, the second substrate 112 has a longitudinal section with a plurality of semi-elliptical shapes that are similar to a trapezoid and successively connected. However, the longitudinal section of the second substrate 112 is not limited to the semi-elliptical shapes, and other shapes, such as a semicircle, a triangle, or a quadrangle, may alternatively be used in the longitudinal section of the second substrate 112.

Referring to FIGS. 3 and 5, the plurality of discharge chambers 140 and the plurality of chamber partitions 320 constitute a discharge portion 310. The second fluorescent layer 132 is deposited between the discharge chambers 140 and the second substrate 112 at a predetermined thickness. In other words, the discharge portions 140 are formed by the first fluorescent layer 130 and the second fluorescent layer 132 which are formed opposite to each other. The chamber partitions 320 are formed between the respective discharge chambers 140 to partition the discharge portion 310. The chamber partitions 320 are deposited to adjoin the second substrate 112 to the first fluorescent layer 130. The second substrate 112 may be formed of a transparent glass substrate similar to the first substrate 110. Alternatively, the second substrate 112 may be formed of other transparent materials.

Referring to FIG. 5, the chamber partitions 320 are formed by closely adhering the second fluorescent layer 132 to the reflecting layer 120. In particular, air existing in the discharge chambers 140 is exhausted to provide a vacuum state therein after adhering the first substrate 110 to the second substrate 112. A discharge gas used to generate a plasma discharge is then injected into the discharge chambers 140. A gas pressure of the discharge gas differs from an outer atmospheric pressure. For this reason, the second fluorescent layer 132 is closely adhered to the reflecting layer 120.

The first fluorescent layer 130 and the second fluorescent layer 132 emit visible light rays using ultraviolet rays generated through the plasma discharge that occurs in the discharge chambers 140. The reflecting layer 120 reflects the visible light rays generated by the first fluorescent layer 130 and the second fluorescent layer 132 upon the second substrate 112 and prevents the visible light rays from leaking through the first substrate 110.

Referring to FIG. 3, the discharge portion 310 of the surface light source body 300 includes a first region RE1 that is covered by the support frame 202 and is not externally exposed, and a second region RE2 that is not covered by the support frame 202 and corresponds to the window 238. The second region RE2 of the discharge portion 310 makes up an effective light-emitting region where visible rays are emitted through plasma discharge at the discharge portion 310 of the surface light source body 300.

The second outer electrode portion 102 is formed on an upper portion of both ends of the second substrate 112 to correspond with the first outer electrode portion 100 such that an electric potential can be generated therebetween. Specifically, the second outer electrode portion 102 corresponds to the first region RE1 and extends across the discharge portion 310.

FIG. 6 is a sectional view of the surface light source unit taken along line Y-Y′ of FIG. 3 according to an embodiment of the present general inventive concept. Referring to FIG. 6, the surface light source unit includes a first outer electrode portion 100, a first substrate 110, a reflecting layer 120, a first fluorescent layer 130, a second fluorescent layer 132, a second substrate 112, a second outer electrode portion 102, a first frit 600, and a second frit 602. The first outer electrode portion 100, the first substrate 110, the reflecting layer 120, the first fluorescent layer 130, the second fluorescent layer 132, the second substrate 112, and the second outer electrode portion 102 are the same as above. Therefore, a description thereof will not be provided.

The first frit 600 is deposited on the reflecting layer 120, and may have the same size as that of the first outer electrode portion 100. However, the first frit 600 may alternatively have a size that is greater than that of the first outer electrode portion 100. In this case, the right end of the first frit 600 is deposited to correspond with the first outer electrode portion 100 in a straight line. The left end of the first frit 600 may or may not be deposited to correspond with the first outer electrode portion 100 in a straight line. The first fluorescent layer 130 is deposited on a region adjacent to where the first frit 600 is deposited.

The first frit 600 may be formed of a material containing lead oxide (PbO). The first frit 600 containing PbO may have a thickness of 100 micrometers (μm) or less. PbO has a secondary electron emitting coefficient that is several times greater than that of glass but has low intensity. When PbO is mixed with glass, a softening temperature decreases to 450° C. and a high level of adhesion between PbO and glass can be obtained. In addition to PbO, the first frit 600 may also contain an alkali metal oxide such as MgO, BaO, CeO, and SrO.

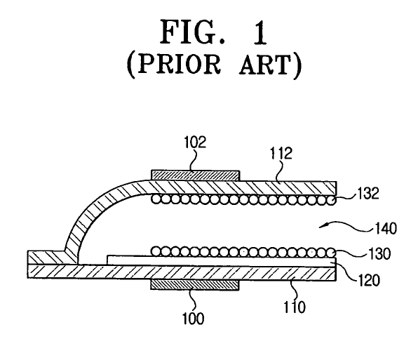

Accordingly, a number of secondary emitting electrons produced based on the same amount of power can be increased. The secondary emitting electrons are produced as a result of the matter of the first frit 600 and/or the second frit 602 interacting with visible light produced by the first fluorescent layer 130 and/or the second fluorescent layer 132. Thus, the first and second fluorescent layers 130 and 132 emit a primary light and the first and second frits 600 and 602 emit a secondary light, in response to the primary light. The increased number of secondary electrons can minimize an effect of a dark portion generated in the conventional surface light source unit of FIG. 1.

The second frit 602 is deposited on the bottom surface of the second substrate 112, and may have the same size as that of the second outer electrode portion 102. However, the second frit 602 may alternatively have a size that is greater than that of the second outer electrode portion 102. The second frit 602 may be made of the same material as that of the first frit 600.

FIG. 7 is a sectional view of the surface light source unit 210 taken along line Y-Y′ of FIG. 3 according to another embodiment of the present general inventive concept. Referring to FIG. 7, the surface light source unit 210 includes the first outer electrode portion 100, the first substrate 110, the reflecting layer 120, the first fluorescent layer 130, the second fluorescent layer 132, the second substrate 112, the second outer electrode portion 102, the first frit 600, and the second frit 602. The second frit 602 of FIG. 7 is deposited in the same manner as that of FIG. 6. However, the first frit 600 of FIG. 7 is deposited in a different manner from that of FIG. 6.

In the embodiment of FIG. 7, the first frit 600 is deposited on the first substrate 110 as opposed to the reflecting layer 120. In this case, an area of a deposition region of the reflecting layer 120 decreases. Additionally, as illustrated in FIG. 7, the first frit 600 may have a deposition thickness that is greater than that of the second frit 602.

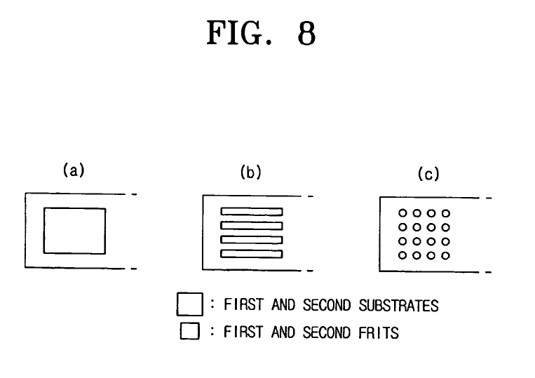

FIG. 8 illustrates a structure of the first frit 600 deposited on the first substrate 100 and the second frit 602 deposited on the second substrate 112 according to embodiments of the present general inventive concept. Although FIG. 8 illustrates only three types of deposition structures, other types of deposition structures of the first and second frits 600 and 602 may alternatively be used with the present general inventive concept.

In (a) of FIG. 8, a rectangular region is defined on the first substrate 110 and/or the second substrate 112, and then the first frit 600 and/or the second frit 602 are deposited to fill the defined rectangular region. In (b) of FIG. 8, a plurality of rectangular regions spaced apart by a predetermined width interval are defined on the first substrate 110 and/or the second substrate 112. The first frit 600 and/or the second frit 602 are then deposited on the defined rectangular regions. In (c) of FIG. 8, a plurality of circular regions are defined on the first substrate 110 and/or the second substrate 112. The first frit 600 and the second frit 602 are then deposited on the defined plurality of circular regions.

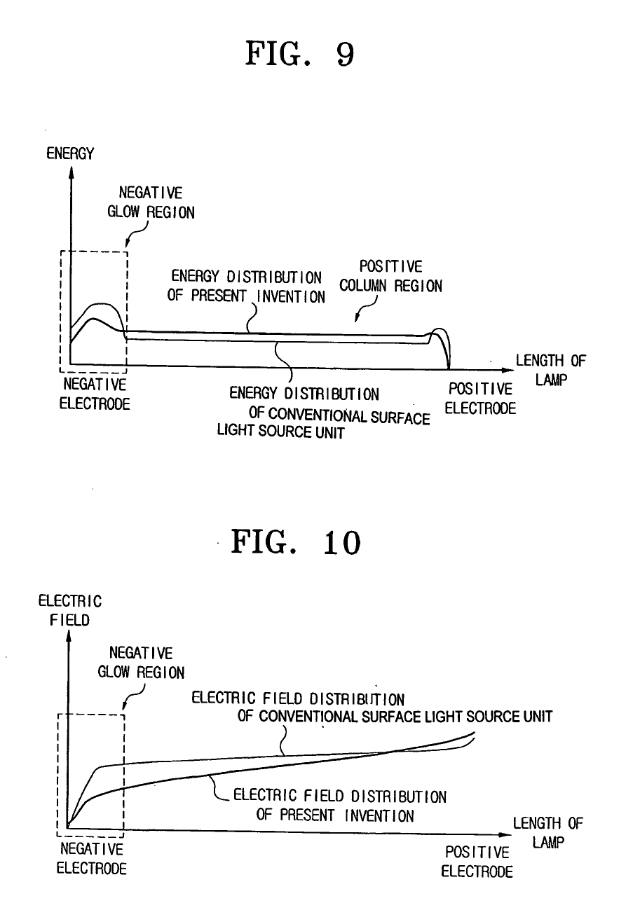

FIG. 9 illustrates a difference between an energy distribution of the conventional surface light source unit of FIG. 1 and an energy distribution of the surface light source unit 210 of the embodiments of the present general inventive concept, and FIG. 10 illustrates a difference between an electric field distribution of the conventional surface light source unit of FIG. 1 and an electric field distribution of the surface light source unit 210 of the embodiments of the present general inventive concept.

When a voltage is applied to a discharge portion of the surface light source unit of the embodiments of the present general inventive concept, the discharge portion is divided into a negative glow region and a positive column region. In the negative glow region, ultraviolet rays that excite a fluorescent substance occur in a small energy range and energy consumption is high. For this reason, the negative glow region is dark and generates much heat. However, as illustrated in FIG. 9, the embodiments of the present general inventive concept increase an amount of the secondary electrons in the negative glow region. As a result, the energy consumption decreases in comparison with energy consumption of the conventional surface light source unit of FIG. 1. Thus, surplus energy from the negative glow region is used in the positive column region, and the amount of the secondary electrons emitted increases, thereby increasing light efficiency.

Generally, an electric field is proportional to energy. Referring to the negative glow region of FIG. 10, the electric field of the surface light source unit of the embodiments of the present general inventive concept is smaller than that of the conventional surface light source unit of FIG. 1. In other words, energy consumed in the negative glow region is less in the surface light source unit of the embodiments of present general inventive concept in comparison with the conventional surface light source unit of FIG. 1.

In addition, a discharge aging process is performed to further increase the amount of the secondary electrons emitted. The discharge aging process enables normal lighting by removing impurities in a vicinity of the fluorescent substance or the electrode in the discharge chambers. An alkali metal oxide contained in a frit is mixed with water in the air during a manufacturing process of the LCD device. The mixture is hardened to form impurities on a surface of the frit. The surface light source unit is driven at high current for a certain amount of time to remove the impurities. The frit, which has a high secondary electron emitting coefficient, is exposed at an outer wall of the discharge chambers as the impurities are removed by driving the surface light source unit at the high current.

As described above, since the frit is formed at the outer wall of the discharge chambers, the amount of the secondary electrons emitted increases and the dark portion that may be generated around a perimeter of the surface light source unit can be minimized to enlarge an effective light-emitting region. Therefore, luminance of light emitted from the surface light source unit can be uniformly controlled to improve display quality.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A surface light source unit usable with an LCD device, comprising:
a first substrate and a second substrate;
a discharge portion formed between the first substrate and the second substrate;
a first outer electrode portion disposed on the first substrate outside the discharge portion to be supplied with power; and
a first frit disposed on the first substrate inside the discharge portion and opposite the first outer electrode portion,
wherein the discharge portion performs a discharge according to the power supplied to the first outer electrode portion.

2. The surface light source unit of claim 1, further comprising:
a second frit disposed on the second substrate inside the discharge portion across from the first frit; and
a second outer electrode portion disposed on the second substrate outside the discharge portion and opposite the second frit.

3. The surface light source unit of claim 2, further comprising:
a first fluorescent layer disposed along a length of the discharge portion on an inner bottom surface thereof and extending to the first frit; and
a second fluorescent layer disposed along the length of the discharge portion on an inner top surface thereof and extending to the second frit.

4. The surface light source unit of claim 2, wherein the first frit and the second frit have sizes that correspond to sizes of the first outer electrode portion and the second outer electrode portion, respectively.

5. The surface light source unit of claim 2, wherein at least one of the first and second frits comprises PbO.

6. The surface light source unit of claim 2, further comprising:
a reflecting layer disposed between the first substrate and the first frit.

7. The surface light source unit of claim 2, wherein the first and second frits contain an alkali metal oxide.

8. The surface light source unit of claim 7, wherein the alkali metal oxide comprises one of MgO, BaO, CeO, and SrO.

9. The surface light source unit of claim 2, wherein the first and second frits each have a thickness of 100 μm or less.

10. The surface light source unit of claim 2, wherein the first and second frits comprise one of a rectangular structure, a straight line patterned structure, and a one-dimensional repeated shape structure.

11. The surface light source unit of claim 2, wherein the first frit has the same size as that of the first outer electrode portion.

12. A surface light source unit usable with an LCD device, comprising:
a transparent body having at least one hollow discharge chamber;
a first electrode disposed on a first outer surface of the transparent body along at least one end thereof to create an electrostatic potential in the at least one discharge chamber to produce a gas discharge so that a primary light is generated; and
a secondary electron emitting part disposed on an inner surface of the at least one discharge chamber and at an end thereof to emit a secondary light in response to the primary light.

13. The surface light source unit of claim 12, wherein the transparent body has a plurality of longitudinal discharge chambers each including:
at least one fluorescent layer disposed therein to emit the primary light in response to ultraviolet light produced by the gas discharge;
a reflecting layer disposed between an inner surface of the respective discharge chamber and the at least one fluorescent layer to direct the primary light toward an output surface of the transparent body; and
the first electrode and a second electrode disposed on top and bottom surfaces of ends of the plurality of longitudinal discharge chambers, and the secondary light emitting part includes first and second frits disposed adjacent to the at least one fluorescent layer on an inner surface of the plurality of longitudinal discharge chambers.

14. The surface light source unit of claim 12, further comprising:
a fluorescent light unit disposed inside the at least one discharge chamber to emit the primary light in response to ultraviolet rays generated by the plasma discharge.

15. The surface light source unit of claim 12, wherein the first electrode is disposed at both longitudinal ends of the transparent body, and the transparent body has a flat rectangular shape having a light emitting region and a non-light emitting region that corresponds to the first electrode.

16. The surface light source unit of claim 15, further comprising:
a second electrode disposed at both longitudinal ends of the transparent body on a second outer surface thereof that is opposite to the first outer surface such that the first and second electrodes have the at least one discharge chamber disposed therebetween.

17. The surface light source unit of claim 15, wherein the secondary electron emitting part is disposed in the non-light emitting region of the transparent body to emit secondary electrons.

18. The surface light source unit of claim 12, wherein the first electrode creates a non-light emitting region in an output surface of the transparent body, and the secondary electron emitting part is disposed in the non-light emitting region.

19. A surface light source unit usable with an LCD device, comprising:
a transparent body having at least one chamber;
a primary light emitting part to generate primary light according to a predetermined voltage applied to the at least one chamber;
one or more electrodes disposed at predetermined locations on a surface of the transparent body such that transparent body has a light emitting portion and a non-light emitting portion that is blocked by the one or more electrodes; and
a secondary light emitting part disposed inside the transparent body at the predetermined locations to generate a secondary light in response to the primary light.

20. The surface light source unit of claim 19, wherein the primary light emitting part comprises a fluorescent layer disposed on an inner surface of the at least one chamber in the light emitting portion of the transparent body to transmit visible light in response to ultraviolet light produced by a gas discharge, and the secondary light emitting part comprises one or more frits disposed inside the at least one chamber beneath the one or more electrodes to emit secondary electrons in the non-light emitting portion of the transparent body.

21. A surface light source unit usable with an LCD device, comprising:
a plurality of gas discharge chambers each comprising:
a first electrode disposed at an end thereof on an outer bottom surface;
a second electrode disposed at the end thereof on an outer top surface;
a reflecting layer disposed on an inner bottom surface thereof;
at least one fluorescent layer disposed on at least one of the reflecting layer and an inner top surface thereof; and
at least one frit disposed adjacent to the at least one fluorescent layer.

22. The surface light source unit of claim 21, wherein the plurality of gas discharge chambers are formed by a first transparent substrate having a flat shape and a second substrate having a periodic non-flat shape adhered to the first substrate to define the plurality of gas discharge chambers and a plurality of chamber partitions disposed between respective gas discharge chambers.

23. The surface light source unit of claim 22, wherein the first and second transparent substrates transmit visible light and block ultraviolet light.

24. A surface light source unit usable with an LCD device, comprising;
a transparent body having a light emitting region and a blocked non-light emitting region; and
at least one secondary light emitting unit disposed in the blocked non-light emitting region to emit secondary light in response to primary light emitted in the lighting emitting region.

25. The surface light source unit of claim 24, wherein the transparent body has a rectangular shape including a plurality of longitudinal discharge chambers and at least one electrode that causes the blocked non-light emitting region around a perimeter of the transparent body.

26. The surface light source unit of claim 25, wherein the plurality of longitudinal discharge chambers contain a plasma gas to emit ultraviolet light when a voltage applied to the at least one electrode exceeds a predetermined threshold.

27. The surface light source unit of claim 24, wherein the at least one secondary light emitting unit comprises a frit containing PbO.

28. The surface light source unit of claim 24, wherein, during operation, the transparent body comprises a gas discharge portion that is divided into a negative glow region that corresponds to the blocked non-light emitting region and a positive column region that corresponds to the light emitting region.

29. The surface light source unit of claim 28, further comprising:
at least one primary light emitting unit disposed in the light emitting region of the transparent body to emit the primary light,
wherein the secondary light emitted in the negative glow region reduces an amount of energy consumed by the primary light emitting unit.

30. An LCD device, comprising:
a support case including a support frame having a window;
an LCD panel provided in the support case to display images using incident light; and
a surface light source unit to emit light to the LCD panel, the surface light source unit including:
a first substrate and a second substrate,
a discharge portion formed between the first substrate and the second substrate,
a first outer electrode portion disposed on the first substrate outside the discharge portion to be supplied with power,
a first frit disposed on the first substrate inside the discharge portion opposite the first outer electrode portion, wherein the discharge portion performs a discharge according to the power supplied to the first outer electrode portion.

31. The LCD device of claim 30, wherein the surface light source unit further includes:
a second frit disposed on the second substrate inside the discharge portion and across from the first frit, and
a second outer electrode portion disposed on the second substrate outside the discharge portion and opposite the second frit.

32. The LCD device of claim 31, wherein at least one of the first and second frits comprise PbO.

33. The LCD device of claim 31, wherein the surface light source unit further includes a reflecting layer disposed between the first substrate and the first frit.

34. The LCD device of claim 31, wherein the first and second frits contain an alkali metal oxide.
